(19) United States
(12) Patent Application Publication
(10) Pub. No.: US 2024/0249743 A1
(43) Pub. Date: Jul. 25, 2024

(54) Enhancing Audio Content of a Captured Sense

(71) Applicant: Google LLC, Mountain View, CA (US)

(72) Inventor: Snehitha Singaraju, Hyderabad, Telangana (IN)

(21) Appl. No.: 18/562,663

(22) PCT Filed: May 25, 2021
(86) PCT No.: PCT/US2021/034078

§ 371 Date: Nov. 20, 2023

(51) Int. Cl. G10L 21/0364; G06V 10/70; G06V 20/40; G06V 20/50; G10L 21/034; G10L 25/57

(52) U.S. Cl. CPC G10L 21/0364; G06V 10/768; G06V 20/40; G06V 20/50; G10L 21/034; G10L 25/57

(57) ABSTRACT

This document describes systems and methods for enhancing dynamically audio content of a captured scene (104). As part of the described systems and methods, an electronic device (102) may include a content-enhancement manager module (216) that directs the electronic device (102) to perform operations to enhance the audio content. Operations may include determining a context (504) surrounding the capture of the scene, determining an audio focus point (604) within the scene, or determining an intent of a user directing the electronic device (102) to capture the scene (104). Based on one or more of these determinations, the electronic device (102) may use a variety of techniques to enhance the audio content associated with the captured scene so as to present the captured scene (104) with relevant audio content.

### BACKGROUND

An electronic device, such as a smartphone, is commonly equipped with one or more sensors to capture content of a scene. For example, the electronic device may include at least one image sensor to capture image content of the scene and at least one audio sensor to capture audio content of the scene or audio content that is in proximity to the electronic device but outside a field of view of the at least one image sensor.

While capturing the scene, the electronic device may capture audio content that includes multiple sounds, such as a dog barking, an airplane flying overhead, or background noise generated by an air conditioning unit. The multiple sounds may also include multiple conversations amongst multiple people within the scene or people (including a user holding the electronic device) near the electronic device but outside the field of view of the at least one image sensor. In general, when presenting the scene to the user, either in real-time or as part of a recording, the electronic device may be limited to presenting the audio content as nominally captured, including each of the multiple sounds.

### SUMMARY

This document describes systems and methods for enhancing audio content of a captured scene. As part of the described systems and methods, an electronic device may include a content-enhancement manager module that directs the electronic device to perform operations to enhance the audio content. Operations may include determining a context associated with the capture of the scene, determining an audio focus point within the scene, or determining an intent of a user directing the electronic device to capture the scene. Based on one or more of these determinations, the electronic device may use a variety of techniques to enhance dynamically the audio content associated with the captured scene so as to present the captured scene with relevant audio content.

In some aspects, a method performed by an electronic device is described. The method includes the electronic device capturing a scene, including image content and audio content. The method further includes determining a context associated with the capturing of the scene. The method continues to include the electronic device enhancing the audio content based at least in part on the determined context and presenting the image content and the enhanced audio content.

In other aspects, a method performed by an electronic device is described. The method includes the electronic device capturing a scene, including image content and audio content. The method further includes determining an audio focus point within the scene. The method continues to include the electronic device enhancing the audio content based at least in part on the determined audio focus point and presenting the image content and the enhanced audio content.

In yet other aspects, an electronic device is described. The electronic device includes an image sensor, an audio sensor, a display, a speaker, and a processor. The electronic device also includes a computer-readable storage medium that stores instructions of a content-enhancement manager module that, when executed by the processor, directs the electronic device to perform a series of operations.

The series of operations includes (i) capturing image content of a scene using the video sensor and audio content of the scene using the audio sensor, (ii) determining an intent of a user instructing the electronic device to capture the image content and the audio content, (iii) enhancing, based at least in part on the determined intent, the audio content, and (iv) presenting the image content using the display and the enhanced audio content using the speaker.

The details of one or more implementations are set forth in the accompanying drawings and the following description. Other features and advantages will be apparent from the description, the drawings, and the claims. This Summary is provided to introduce subject matter that is further described in the Detailed Description. Accordingly, a reader should not consider the Summary to describe essential features nor limit the scope of the claimed subject matter.

### BRIEF DESCRIPTION OF THE DRAWINGS

The details of one or more aspects of enhancing audio content of a captured scene are described below. The use of the same reference numbers in different instances in the description and the figures indicate similar elements:

FIG. 1 illustrates an example operating environment in which enhancing audio content of a captured scene may be implemented;

FIG. 2 illustrates an example implementation of an electronic device in accordance with one or more aspects;

FIG. 3 illustrates details of an example user interface that may be presented through a display of an electronic device in accordance with one or more aspects;

FIG. 4 illustrates details of enhancing audio content and enhancing complementary image content in accordance with one or more aspects;

FIG. 5 depicts an example method performed by an electronic device in accordance with one or more aspects;

FIG. 6 depicts another example method performed by an electronic device in accordance with one or more aspects; and

FIG. 7 depicts another example method performed by an electronic device in accordance with one or more aspects.

### DETAILED DESCRIPTION

### Overview

This document describes systems and methods for enhancing audio content of a captured scene. As part of the described systems and methods, an electronic device may include a content-enhancement manager module that directs the electronic device to perform operations to enhance the audio content. Operations may include determining a context associated with the capture of the scene, determining an audio focus point within the scene, or determining an intent of a user directing the electronic device to capture the scene. Based on one or more of these determinations, the electronic device may use a variety of techniques to enhance dynamically the audio content associated with the captured scene so as to present the captured scene with relevant audio content.

The systems and methods of the present application overcome limitations of conventional techniques that capture and present audio content of a scene. As an example, conventional techniques may capture and present audio content that is not relevant to the scene nor desired by a user (e.g., conventional techniques may capture and present background noises such as a dog barking, a jet engine, an air conditioning unit, or a conversation that is muddled through multiple people talking at the same time). Although conventional techniques may perform some degree of noise suppression, such noise suppression is predetermined and inflexible (e.g., fixed to suppress certain noises in all situations) and not able to dynamically draw out audio content that is relevant to the scene or desired by the user.

In contrast, the systems and methods of the present application may capture and present audio content that is relevant to the scene and is desired by the user. For instance, the systems and methods as described below may use a context, an audio focus point, or an intent of a user to capture and enhance audio content of the scene. Given different contexts, audio focus points, or intents, the described techniques may draw out different mixes of audio content for a captured scene.

As an example, for a scene that is being captured indoors (e.g., a context), a sound corresponding to a door slamming in the background (e.g., a door not visible in the scene) may be suppressed while sounds corresponding to a conversation may be amplified. However, for a scene being captured outdoors (e.g., another context), a sound corresponding to a door slamming in the foreground (e.g., a door visible in the scene) may not be suppressed.

As another example, for a scene where audio focus points have been identified that correspond to a conversation between two people, a sound corresponding to a dog barking (e.g., a dog visible in the scene) may be suppressed. Conversely, and for the same scene, if the audio focus point corresponds to the dog barking, sounds corresponding to the conversation between the two people may be suppressed.

The discussion below describes an example operating environment and system followed by example methods. The discussion further includes additional examples. The discussion may generally apply to enhancing audio content of a captured scene.

### Example Operating Environment and System

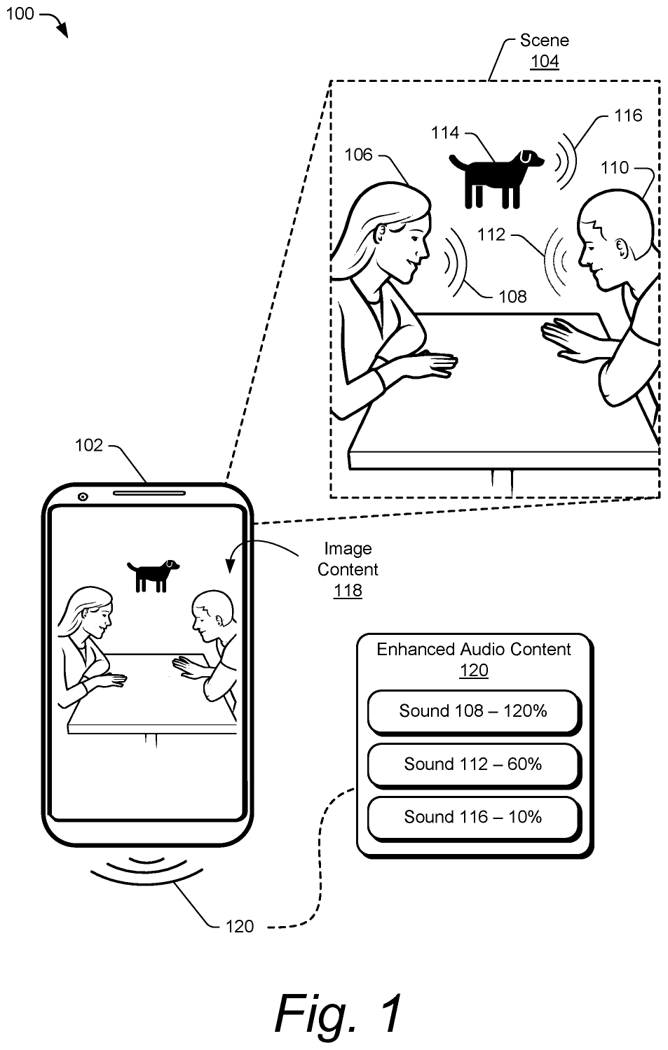

FIG. 1 illustrates an example operating environment 100 in which enhancing audio content of a captured scene may be implemented. Within the operating environment 100, an electronic device 102 performs operations that include capturing and presenting a scene 104. In some instances, the electronic device 102 may present the scene 104 in real time (e.g., present the scene 104 at or in temporal proximity to a time of capture). In other instances, the electronic device 102 may present the scene 104 later (e.g., present a recording of the scene 104). Presenting the scene 104 may include presenting a combination of image content (e.g., still images, video) and/or audio content.

Although the electronic device 102 is illustrated as a smartphone, the electronic device 102 may be one of many types of devices with capabilities to capture a scene and present image and/or audio content. As example alternatives to the illustrated smartphone, the electronic device 102 may be a tablet, a laptop computer, a wearable device, and so on. Furthermore, portions of the electronic device 102 may be distributed (e.g., a portion of the electronic device 102, such as a security camera, may be located near the scene 104, whereas another portion of the electronic device 102, such as a monitor, may be located remotely from the scene 104).

Multiple sources of sound may be within the scene 104. For instance, a source 106 (e.g., a person in a left portion of the scene 104) is producing a sound 108 (e.g., speech), another source 110 (e.g., another person in a right portion of the scene 104) is producing another sound 112 (e.g., speech), and another source 114 (e.g., a dog in a center portion of the scene 104) is producing another sound 116 (e.g., barking). In some instances, captured sounds of the scene 104 may be attributable to sources not in the field of view of an image sensor of the electronic device 102 (e.g., an air conditioning unit near the scene 104, a jet flying overhead, or a person nearby may be generating sounds, but not be visible within the scene 104).

While presenting the scene 104 (e.g., presenting the scene 104 in real time or during a playback of a recording), the electronic device 102 may present image content 118 on a display of the electronic device 102 and present enhanced audio content 120 through a speaker of the electronic device 102. The enhanced audio content 120 may include one or more sounds (e.g., the sound 108, the sound 112, the sound 116) altered by the electronic device 102.

In general, the electronic device 102 may use analog signal processing and/or digital signal processing to alter the sounds. Furthermore, the electronic device 102 may base the altering of the sounds on factors such as a context that may be associated with the capturing of the scene 104, an audio focus point within the scene 104, or an intent of a user directing the electronic device 102 to capture the scene 104.

In view of FIG. 1, and as an example, altering the sounds may include scaling a magnitude of the sound 108 (e.g., the sound from the source 106) to 120% of its nominally captured volume (e.g., in decibels (dB)), scaling a magnitude of the sound 112 (e.g., the sound from the source 110) to 60% of its nominally-captured volume, and further scaling a magnitude of the sound 116 to 10% of its nominally-captured volume. Altering the sounds may also include performing a denoising operation that eliminates sounds of a predetermined or selected frequency range (e.g., a stationary or white noise such as an air conditioner, a non-stationary noise such as a jet engine or dog barking, and so forth).

As described herein, the electronic device 102 may use a variety of techniques to determine a basis to alter the sounds and generate the enhanced audio content 120. For instance, the techniques may include using sensors of the electronic device 102 to determine a context surrounding the capture of the scene 104. The techniques may also include using a machine-learned model (e.g., a neural network model, an audio-visual trained model) as part of determining the context or determining an intent of a user instructing the electronic device 102 to capture the scene 104.

In some instances, the electronic device 102 may provide the user of the electronic device 102 the ability to configure the electronic device 102 to alter either the act of capturing sounds of the scene 104 or to alter recorded sounds of the scene 104. In general, and based on these techniques, the electronic device 102 may draw out audio content (e.g., the enhanced audio content 120) that is relevant to the scene 104 and/or desired by the user.

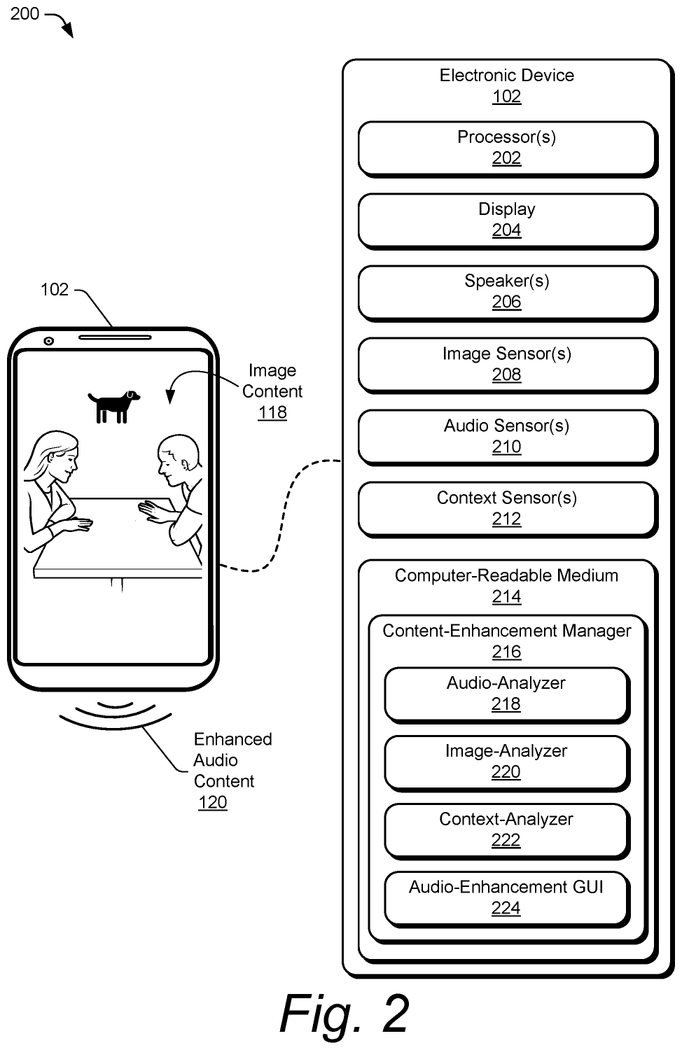

In more detail, consider FIG. 2, which illustrates an example implementation 200 of the electronic device 102 of FIG. 1. The electronic device 102 includes one or more processor(s) 202, a display 204, and one or more speakers(s) 206. In some instances, the speaker(s) 206 of the electronic device 102 may include a speaker that is separate from the electronic device (e.g., a wireless speaker or a remotely-wired speaker). The processor(s) 202 can include a core processor or a multiple-core processor composed of a variety of materials, such as silicon, polysilicon, high-K dielectric, copper, and so on. The display 204 can include any suitable display device, e.g., a touchscreen, a liquid crystal display (LCD), thin film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth.

As will be described in greater detail below, the processor(s) 202 may process executable code or instructions from a combination of modules. As a result of processing the executable code or instructions, the processor(s) 202 may direct the electronic device 102 to capture a scene (e.g., the scene 104 of FIG. 1), present the image content 118 of the scene through the display 204, and present the enhanced audio content 120 through the speaker(s) 206.

The electronic device 102 may include a combination of sensors. The combination of sensors may include one or more image sensor(s) 208. Examples of the image sensor(s) 208 include a complementary metal oxide semiconductor (CMOS) image sensor and a charge-coupled device (CCD) image sensor. As part of capturing image content of a scene (e.g., the image content 118), the image sensors(s) 208 may detect electromagnetic light waves reflected from features within the scene and convert the electromagnetic light waves to digital data. Capturing the image content may include capturing still image content and/or video image content (e.g., a series of video frames that capture motion within the scene).

The combination of sensors may further include one or more audio sensor(s) 210. As part of capturing audio content, the audio sensor(s) 210 may detect sound waves of the scene and convert the sound waves into a type of audio content (e.g., digital audio content). In some instances, the audio sensor(s) 210 may be distributed across different locations of the electronic device 102. Furthermore, the audio sensor(s) 210 may be directionally configurable (e.g., configurable using beamforming techniques) to detect sound waves from one or more sources or audio focus points within the scene. In some instances, the audio sensor(s) 210 may be integrated with (e.g., part of) the speaker(s) 206.

One or more context sensor(s) 212 may also be included in the combination of sensors. Examples of the contexts sensor(s) 212 include a global navigation satellite system (GNSS) sensor that can detect signaling to track a location of the electronic device 102, an accelerometer that can detect a motion of the electronic device 102, a temperature sensor that can detect an ambient sensor surrounding the electronic device 102, or an atomic clock sensor that can detect signaling that indicates a time, day, or date. Another example of the context sensor(s) 212 includes a detecting sensor such as a radar sensor, which may detect motion or movement of the electronic device 102 or motion or movement of features within the scene. In general, the context sensor(s) 212 may provide inputs to the electronic device 102 that are useable to determine a context associated with a capturing of the scene.

The electronic device 102 may include a computer-readable medium (CRM) 214. As described herein, the CRM 214 excludes propagating signals. In general, the CRM 214 may include any suitable memory or storage device such as random-access memory (RAM), static RAM (SRAM), dynamic RAM (DRAM), non-volatile RAM (NVRAM), read-only memory (ROM), or Flash memory useable to store data.

The CRM 214 may also store one or more modules of code that are executable by the processor(s) 202. For example, the CRM 214 may store a content-enhancement manager module 216 that includes an audio-analyzer module 218, an image-analyzer module 220, a context-analyzer module 222, and an audio-enhancement graphical user interface (GUI) module 224. In some instances, one or more portions of the content-enhancement manager module 216 may include executable algorithms that perform machine-learning techniques.

The audio-analyzer module 218 may include executable code that, upon execution by the processor(s) 202, performs audio content analysis. In some instances, performing the audio content analysis may include analyzing one or more qualities of sounds from a captured scene, such as a frequency, a volume, an interval, a duration, a signal-to-noise ratio, and so on. Based on the audio content analysis, the audio-analyzer module 218 may classify one or more sounds as a type of sound (e.g., classify a sound as an ambient sound, a voice, an interruptive anomaly, a stationary sound, white noise, and so on). In some instances, classifying the sounds may include comparing captured sounds to baseline or reference sounds stored within the audio-analyzer module 218.

The image-analyzer module 220 may include executable code that, upon execution by the processor(s) 202, performs image content analysis. For example, performing the image content analysis may include using image-recognition techniques to evaluate visible features within a captured scene. Using such image-recognition techniques, the image-analyzer module 220 may identify one or more persons within the captured scene, identify a setting (e.g., a sunset at a beach), identify objects that are in motion, and so on. In some instances, performing image content analysis may be based on the identification of an image focal point (e.g., a point at which the image content sensor(s) 208 is aimed or focused).

The context-analyzer module 222 may include executable code that, upon execution by the processor(s) 202, performs an analysis to determine a context. In general, the context-analyzer module 222 may combine inputs from the context sensor(s) 212, inputs from the audio-analyzer module 218, and/or inputs from the image-analyzer module 220 to determine the context. For example, the context-analyzer module 222 may combine an input from a radar sensor (e.g., the context sensor(s) 212) that detects motion within the scene with an input from the audio-analyzer module 218 that classifies sounds within the scene as a crowd cheering. Based on the combination of inputs, the context-analyzer module 222 may determine that a context surrounding the capturing of the scene is a sporting event.

As another example, the context-analyzer module 222 may combine input from the radar sensor with an input from the image-analyzer module 220 to determine that the electronic device 102 is “zooming” into a scene that includes a conversation amongst multiple persons. For instance, if the image-analyzer module 220 detects a magnifying operation of captured image content and the radar sensor detects that distances between the electronic device 102 and the multiple persons are changing, the electronic device 102 may enable or disable one or more of the audio sensor(s) 210. Examples of other contexts the electronic device 102 may determine to include a location (e.g., indoors, outdoors, etc.), a type of scene being captured (e.g., a panorama), a setting (e.g., a party, a family event, a social gathering, a concert, a vacation, a lecture, a speech) and so on.

The audio-enhancement GUI module 224 may include executable code that, upon execution by the processor(s) 202, presents an interface on the display 204 of the electronic device 102. In general, the interface may enable a user to configure the electronic device 102 to enhance captured audio content to the user's liking. In some instances, the user may elect to configure the electronic device 102 to enhance the audio content in real time (e.g., configure a setting of the electronic device 102 that affects the activity of capturing audio content of the scene in real time). In other instances, the user may elect to configure the electronic device 102 to enhance the audio content using post-processing (e.g., configure a setting of the electronic device that affects post-processing a recording of the captured audio content).

The content-enhancement manager module 216 may include executable code that, upon execution by the processor(s) 202, evaluates one or more analyses performed by the audio-analyzer module 218, the image-analyzer module 220, or the context-analyzer module 222 to determine that the captured audio content should be enhanced. In some instances, determining that the captured audio content should be enhanced may include determining an intent of a user directing the electronic device 102 to capture the scene.

To determine the intent of the user, the content-enhancement manager module 216 may use inputs from the audio-enhancement GUI module 224. Inputs from the audio-enhancement GUI module 224 may include inputs that activate or deactivate one or more of the audio sensor(s) 210, identify audio focus points, or alter a setting that impacts capturing, recording, or playback of sounds from the scene. Altering a setting may include, for instance, altering a signal-to-noise ratio setting, a reverb setting, a filtering setting, a spatial audio setting (e.g., an ambience setting), or an audio focus point setting (e.g., a voice setting). In some instances, the intent of the user may be determined by using one or more of the same inputs that are used to determine the context surrounding the capturing of the scene. The audio-enhancement GUI module 224 may also include inputs that specify timing of enhancement mode operations (e.g., enhancement mode operations performed in real-time versus operations performed to a recording of captured content).

The content-enhancement manager module 216 may further use a machine-learned model as part of determining the intent of the user. In addition (or as an alternative) to determining the intent based on inputs (which may be generic for multiple users), determining the intent of the user may be based on a machine-learned model that relies on a user profile or a user identity. For instance, and based on the user profile or the user identity, the machine-learned model may reference a past behavior of the user, such as a past editing of recorded audio content by the user, a detected past behavior of the user for a determined context, a past configuration of the electronic device 102 by the user during capture of a similar scene, selected audio focus points within a scene for a determined context, and so on.

The electronic device 102 may, in some instances, include communication hardware (e.g., wireless communication hardware for cellular communications such as 3rd Generation Partnership Project Long-Term Evolution (3GPP LTE), Fifth Generation New Radio (5G NR), wireless communication hardware for a Wireless Local Area Network (WLAN), and so on). In such instances, the electronic device 102 may communicate information or data to another electronic device to allow some or all functionalities described herein to be performed on behalf of the electronic device 102 by the other electronic device.

In general, execution of the content-enhancement manager module 216 by the processor(s) 202 directs the electronic device 102 to perform some or all of the functionalities described herein. In some instances, executing the content-enhancement manager module 216 may include executing portions or combinations of the audio-analyzer module 218, the image-analyzer module 220, the context-analyzer module 222, or the audio-enhancement GUI module 224.

Although illustrated and described as separate modules for clarity, the audio-analyzer module 218, the image-analyzer module 220, the context-analyzer module 222, or the audio-enhancement GUI module 224 (or portions of each) may be combinable. Furthermore, any of these modules (or portions thereof) may be separate from the content-enhancement manager module 216 such that the electronic device 102 accesses and/or communicates with them remotely (e.g., certain modules of the content-enhancement manager module 216 may reside in a cloud-computing environment).

In some instances and in view of the descriptions above, the electronic device 102 may provide the user with controls allowing the user to make an election as to both if and when systems, programs, or features described herein may enable collection of user information (e.g., the user's preferences with respect to enhancing captured audio content of a scene, information about the user's social network, social actions or activities, profession, the user's current location, the user's contact list), and if the user is sent data or communications from a server. In addition, certain data may be treated in one or more ways before it is stored or used so that personally identifiable information is removed.

For example, a user's identity may be treated so that no personally identifiable information can be determined for the user, or a user's geographic location may be generalized where location information is obtained (such as to a city, ZIP code, or state level) so that a particular location of a user cannot be determined. Thus, the user may have control over what information is collected about the user, how that information is used, and what information is provided to the user.

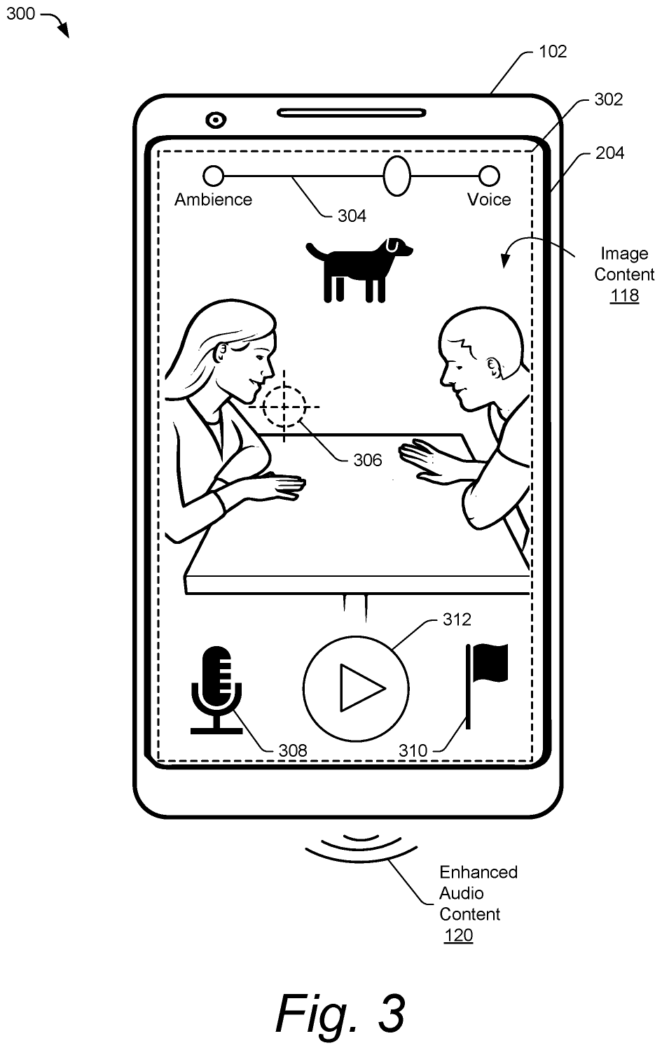

FIG. 3 illustrates details 300 of an example user interface 302 that the electronic device 102 may present through the display 204 in accordance with one or more aspects. The electronic device 102 may implement functionality of the user interface 302 by executing code that presents a graphical user interface (e.g., the processor(s) 202 executing the code of the audio-enhancement GUI module 224 of FIG. 2). In general, and through the user interface 302, a user of the electronic device 102 may configure the electronic device 102 to enhance captured audio content in accordance with the user's intent.

In general, the user interface 302 may present one or more selectable controls or icons through which the user may configure the electronic device 102 (e.g., configure desired functionalities of the electronic device 102 that affect enhancing audio content of a captured scene). Configuring the electronic device 102 may include altering settings that impact functionality of hardware of the electronic device 102 (e.g., the image sensor(s) 208, the audio sensor(s) 210, the context sensor(s) 212), and/or modules containing executable code (e.g., the content-enhancement manager module 216, including the audio-analyzer module 218, the image-analyzer module 220, or the context-analyzer module 222).

In some instances, configuring the electronic device 102 may affect real-time capturing of the scene (e.g., the act of capturing audio content and/or image content), while in other instances, configuring the electronic device 102 may affect post-processing of the content (e.g., altering a recording of the audio content and/or the image content). Based on changing the configuration of the electronic device 102, the user may, in general, cause the electronic device 102 to create multiple versions of the enhanced audio content 120. The user may, further, in some instances, direct the electronic device 102 to store one or more versions of the enhanced audio content 120 on the electronic device 102 (e.g., within the CRM 214 of FIG. 2), transmit one or more of the versions to another device (e.g., upload one or more of the versions to a server), and so on.

In some instances, the user interface 302 may present a slidable mix control 304 that allows the user to select an enhancement mix for the audio content. As an example, while processing digital or analog signals of the audio content, the electronic device 102 (e.g., the processor(s) 202 executing the content-enhancement manager module 216) may affect the mix by amplifying one or more sounds classified as a voice sound and reducing one or more sounds classified as an ambient sound to different magnitudes (or degrees of magnitude in dB) that correspond to a desired audio content mix. Versions of the slidable mix control 304 may include versions that affect a reverb mix, a white noise mix, a frequency mix, and so on.

In some instances, the user interface 302 may present an audio focus point control 306 that allows the user to identify an audio focus point within a scene (e.g., the scene 104 of FIG. 1). In such an instance, the audio focus point may be considered a user-selectable audio focus point.

In some instances, the user may identify the audio focus point prior to, or during, the capturing of the scene. In such instances, identifying the audio focus point may cause one or more audio sensors (e.g., the audio sensor(s) 210 of FIG. 2) to implement beamforming, enable one or more audio sensors, disable one or more audio sensors, and so on. In other instances, the user may identify an audio focus point after the scene has been captured (and prior to the electronic device 102 post-processing the captured scene). In such instances, the electronic device 102 (e.g., the content-enhancement manager module 216) may enhance audio content of the captured scene (e.g., modify a recording of the audio content) to emphasize soundwaves the electronic device 102 determines to have emanated from or near the identified audio focus point. In doing so, and as an example, the content-enhancement manager module 216 may match an input from the audio focus point control 306 to magnitudes of one or more sounds as captured by the one or more audio sensor(s) 210.

The user interface 302 may also present other controls or icons. For example, the user interface 302 may present at least one audio sensor icon 308 (e.g., a microphone icon), through which the user may select to enable or disable an audio sensor, change a setting (e.g., change an audio sensor sensitivity level), and so on. As another example, the user interface 302 may present at least one status icon 310. In some instances, the status icon 310 may indicate that the electronic device 102 is either capturing or presenting the scene in an enhanced audio mode. In other instances, the status icon 310 may be selectable to cause the electronic device 102 to present metadata and/or configuration information (e.g., configuration of the electronic device 102) associated with such an enhanced audio mode.

As yet another example, the user interface 302 may present a playback icon 312. In general, the user may select the playback icon 312 to playback a recording of the scene (e.g., a recording of the image content 118 and the enhanced audio content 120) or use the playback icon 312 (in combination with selecting the audio sensor icon 308, moving the audio focus point control 306, and/or sliding the slidable mix control 304) to create different versions of the enhanced audio content 120 to the user's liking.

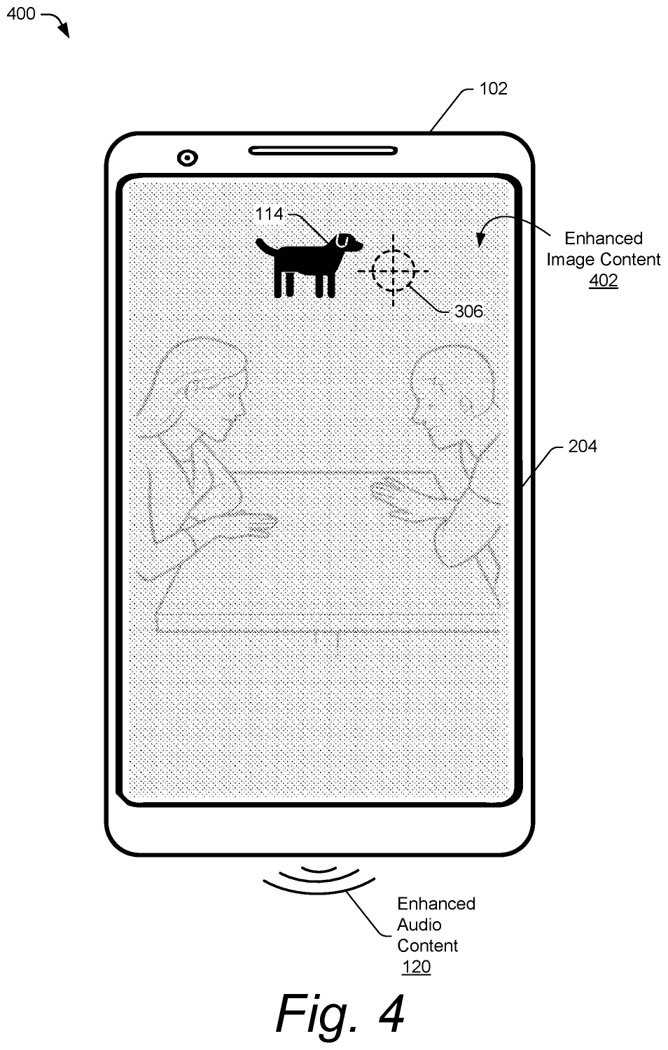

FIG. 4 depicts details 400 of an example aspect of enhancing audio content, and complementary image content, in accordance with one or more aspects. In some instances, and as illustrated in FIG. 4, the electronic device 102 (e.g., the processor(s) 202 executing one or more modules of the content-enhancement manager module 216 of FIG. 2) may enhance both audio content (e.g., the enhanced audio content 120) and image content (e.g., enhanced image content 402).

In combination with previously described techniques that may determine a context surrounding the capture of a scene (e.g., the scene 104 of FIG. 1), an intent of a user directing the electronic device 102 to capture the scene, or an audio focus point within the scene to enhance captured audio content, the electronic device 102 may also enhance complementary captured image content. For example, during the capturing of the scene or the post-processing of the scene, the electronic device 102 may determine that the source 114 (e.g., the dog in the middle of the scene) is an audio focus point. Similarly, the electronic device 102 may also determine that the source 114 is an image focus point.

In some instances, and as illustrated, the source may be determined as the audio focus point and/or the image focus point based on an input made to the electronic device 102 using the previously described audio focus point control 306. In other instances, the source 114 may be determined as the audio focus point and/or image focus point based on the electronic device 102 analyzing audio content, analyzing image content, determining a context, or determining an intent of the user as previously described.

In addition to using analog signal processing and/or digital signal processing to alter sounds and generate the enhanced audio content 120, the electronic device 102 may use analog signal processing and/or digital signal processing to generate the enhanced image content 402. For instance, the electronic device 102 may combine or colorize one or more bits of captured image content to “blur” features of the scene that are irrelevant to the source 114 (e.g., blur features that are not near or proximate to the image focus point, blur background imagery, blur foreground imagery). In such an instance, the blurring effect may allow the source 114 to be visually highlighted (e.g., enhanced) in comparison to other visible features captured by the electronic device 102. Furthermore, the electronic device 102 may dim, fade, or adjust a contrast of the image content to generate the enhanced image content.

In some instances, and as part of enhancing complementary image content, the electronic device 102 may highlight more than one source or audio focus point. As an example, the electronic device 102 may highlight two or three persons having a conversation and visually blur remaining sources of sound or other features within the scene (e.g., background features).

### Example Methods

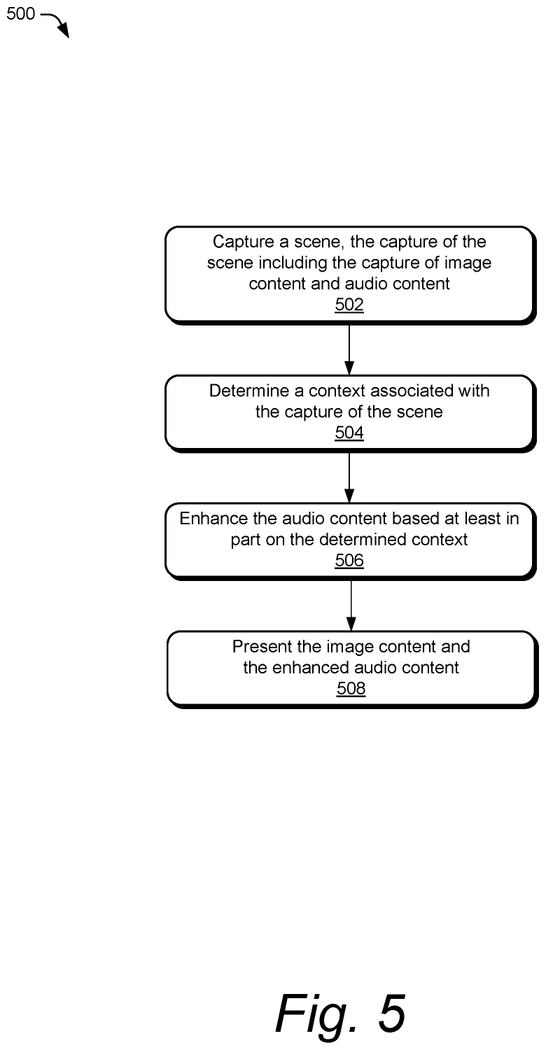

FIGS. 5, 6, and 7 depict example methods 500, 600, and 700, respectively, that are directed to enhancing audio content of a captured scene. In general, the methods 500, 600, and 700 can be performed by the electronic device 102, which uses its processor(s) 202 to execute the content-enhancement manager module 216 and enhance the audio content of the captured scene.

The methods 500, 600, and 700 are shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIG. 1 or to entities or processes as detailed in FIG. 2, 3, or 4, reference to which is made for example only. The techniques are not limited to performance by one entity or multiple entities operating on one device.

FIG. 5 illustrates an example method 500 performed by an electronic device in accordance with one or more aspects. The electronic device may be the electronic device 102 of FIG. 1, capturing the scene 104 of FIG. 1.

At 502, and as part of capturing the scene, the electronic device may capture image content (e.g., the image content 118 including one or more of the sources 106, 110, and 114 of FIG. 1) and audio content (e.g., audio content including one or more of the sounds 108, 112, or 116 of FIG. 1). The electronic device may use one or more image sensors (e.g., the image sensor(s) 208) to capture the image content (e.g., capture still image content or video content) and one or more audio sensors (e.g., the audio sensor(s) 210) to capture the audio content.

At 504, the electronic device (e.g., the processor(s) 202 of the electronic device 102 executing the context-analyzer module 222) may determine a context surrounding the capture of the scene. For example, determining the context may be based, at least in part, on contextual information detected by one or more sensors (e.g., the context sensor(s) 212) of the electronic device (e.g., information indicative of a location of the electronic device or information indicative of a motion of the electronic device, such as GNSS signaling).

As another example, and at 504, determining the context may be based, at least in part, on the electronic device (e.g., the processor(s) 202 executing the image-analyzer module 220) analyzing the image content and/or the electronic device (e.g., the processor(s) 202 executing the audio-analyzer module 218) analyzing the audio content.

Continuing, and at 506, the electronic device (e.g., the processor(s) 202 of the electronic device 102 executing the content-enhancement manager module 216) may, based on the context determined by the electronic device at 504, enhance the audio content. Enhancing the audio content may include using analog or digital signal processing to increase or decrease a magnitude of at least one sound included in the audio content.

At 508, the electronic device (e.g., the display 204) may present the image content (e.g., the image content 118). The electronic device (e.g., the speakers 206) may also present the enhanced audio content (e.g., the enhanced audio content 120).

In some instances, one or more operations of the method 500 described above may be performed in real time (e.g., operations drawn to determining the context, enhancing the audio content, presenting the image content, and/or presenting the enhanced audio content may occur during or in temporal proximity to the capturing of the scene). In other instances, one or more operations of method 500 may be performed during post-processing (e.g., operations drawn to determining the context, enhancing the audio content, presenting the image content, and/or presenting the enhanced audio content may be performed using a recording of the captured scene).

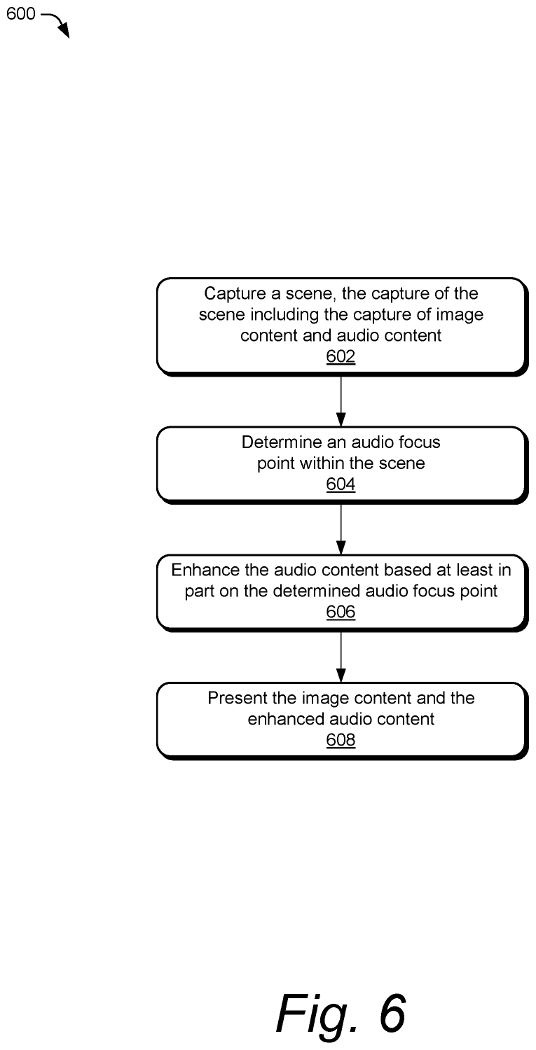

FIG. 6 illustrates an example method 600 performed by an electronic device in accordance with one or more aspects. The electronic device may be the electronic device 102 of FIG. 1, capturing the scene 104 of FIG. 1.

At 602, and as part of capturing the scene, the electronic device may capture image content (e.g., the image content 118 including one or more of the sources 106, 110, and 114 of FIG. 1) and audio content (e.g., audio content including one or more of the sounds 108, 112, or 116 of FIG. 1). The electronic device may use one or more image sensors (e.g., the image sensor(s) 208) to capture the image content and one or more audio sensors (e.g., the audio sensor(s) 210) to capture the audio content.

At 604, the electronic device (e.g., the processor(s) 202 executing the content-enhancement manager module 216) may determine an audio focus point within the scene. In some instances, determining the audio focus point may be based, at least in part, on an input from a user of the electronic device, a context associated with the capturing of the scene, or an analysis of the image content.

Continuing, and at 606, the electronic device (e.g., the processor(s) 202 of the electronic device 102 executing the content-enhancement manager module 216) may, based at least in part on the audio focus point determined by the electronic device at 604, enhance the audio content. At 608, the electronic device (e.g., the display 204) may present the image content (e.g., the image content 118). The electronic device (e.g., the speakers 206) may also present the enhanced audio content (e.g., the enhanced audio content 120).

In some instances, one or more operations of the method 600 described above may be performed in real time (e.g., operations drawn to determining the audio focus point, enhancing the audio content, presenting the image content, and/or presenting the enhanced audio content may occur during or in temporal proximity to the capturing of the scene). In other instances, one or more operations of method 600 may be performed during post-processing (e.g., operations drawn to determining the audio focus point, enhancing the audio content, presenting the image content, and/or presenting the enhanced audio content may be performed using a recording of the captured scene).

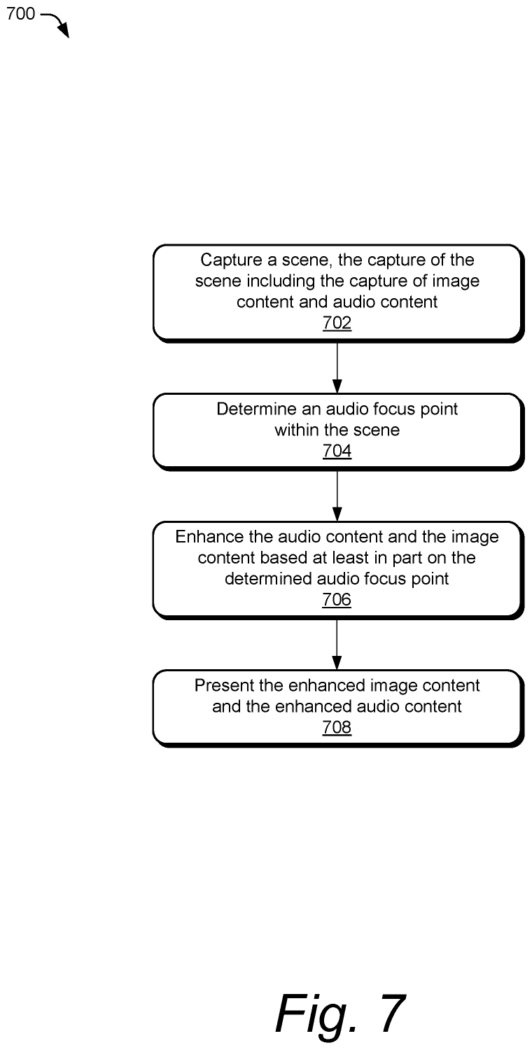

FIG. 7 illustrates an example method 700 performed by an electronic device in accordance with one or more aspects. The electronic device may be the electronic device 102 of FIG. 1, capturing the scene 104 of FIG. 1.

At 702, and as part of capturing the scene, the electronic device may capture image content (e.g., the image content 118 including one or more of the sources 106, 110, and 114 of FIG. 1) and audio content (e.g., audio content including one or more of the sounds 108, 112, or 116 of FIG. 1). The electronic device may use one or more image sensors (e.g., the image sensor(s) 208) to capture the image content and one or more audio sensors (e.g., the audio sensor(s) 210) to capture the audio content.

At 704, the electronic device (e.g., the processor(s) 202 executing the content-enhancement manager module 216) may determine an audio focus point within the scene. Continuing, and at 706, the electronic device (e.g., the processor(s) 202 of the electronic device 102 executing the content-enhancement manager module 216) may, based at least in part on the audio focus point determined by the electronic device at 704, enhance the audio content and the image content. In some instances, enhancing the image content may include blurring at least one feature within the image content that is deemed to be irrelevant to the determined audio focus point.

At 708, the electronic device (e.g., the display 204) may present the enhanced image content (e.g., the enhanced image content 402). The electronic device (e.g., the speakers 206) may also present the enhanced audio content (e.g., the enhanced audio content 120).

In some instances, one or more operations of the method 700 described above may be performed in real time (e.g., operations drawn to determining the audio focus point, enhancing the audio content, enhancing the image content, presenting the enhanced image content, and/or presenting the enhanced audio content may occur during or in temporal proximity to the capturing of the scene). In other instances, one or more operations of method 700 may be performed during post-processing (e.g., operations drawn to determining the audio focus point, enhancing the audio content, enhancing the image content, presenting the enhanced image content, and/or presenting the enhanced audio content may be performed using a recording of the captured scene).

### Additional Examples

Example 1: A method performed by an electronic device comprising: capturing, by the electronic device, a scene, the capturing of the scene including capturing image content and audio content; determining, by the electronic device, a context associated with the capturing of the scene; enhancing, by the electronic device, the audio content based at least in part on the determined context; and presenting, by the electronic device, the image content and the enhanced audio content.

Example 2: The method of example 1, wherein enhancing the audio content includes increasing or decreasing a magnitude of at least one sound included in the audio content.

Example 3: The method of example 1, wherein determining the context associated with the capturing of the scene is based, at least in part, on contextual information detected by one or more sensors of the electronic device.

Example 4: The method of example 3, wherein the contextual information detected by one or more sensors of the electronic device includes information indicative of a location of the electronic device.

Example 5: The method of example 3, wherein the contextual information detected by one or more sensors of the electronic device includes information indicative of a motion of the electronic device.

Example 6: The method of example 1, wherein determining the context associated with the capturing of the scene includes determining the context based, at least in part, on an analysis of the image content by the electronic device.

Example 7: The method of example 1, wherein determining the context associated with the capturing of the scene includes determining the context based, at least in part, on an analysis of the audio content by the electronic device.

Example 8: The method of example 1, wherein enhancing the audio content includes enhancing the audio content in real-time during the capturing of the audio content.

Example 9: The method of example 8, wherein the presenting the scene includes presenting the image content and the enhanced audio content in real-time.

Example 10: The method of example 1, wherein enhancing the audio content includes post-processing a recording of the audio content.

Example 11: The method of example 10, wherein presenting the scene includes presenting a recording of the image content and the post-processed recording of the audio content.

Example 12: The method of example 1, wherein the image content includes video content.

Example 13: The method of example 1, wherein the image content includes still image content.

Example 14: A method performed by an electronic device comprising: capturing, by the electronic device, a scene, the capturing of the scene including capturing image content and audio content; determining, by the electronic device, an audio focus point within the scene; enhancing, by the electronic device, the audio content based at least in part on the determined audio focus point; and presenting, by the electronic device, the image content and the enhanced audio content.

Example 15: The method of example 14, wherein enhancing the audio content includes using beamforming during the capturing of the audio content, the beamforming based at least in part on the determined audio focus point.

Example 16: The method of example 14, wherein the determined audio focus point is based, at least in part, on an input from a user of the electronic device.

Example 17: The method of example 14, wherein the determined audio focus point is based, at least in part, on a context associated with the capturing of the scene.

Example 18: The method of example 14, wherein the determined audio focus point is based, at least in part, on an analysis of the image content.

Example 19: An electronic device comprising: an image sensor; an audio sensor; a display; a speaker; a processor; and a computer-readable storage medium comprising instructions of a content-enhancement manager module that, when executed by the processor, directs the electronic device to: capture, using the image sensor, image content of a scene; capture, using the audio sensor, audio content of the scene; determine an intent of a user instructing the electronic device to capture the scene, including the image content and the audio content; enhance, based at least in part on the determined intent, the audio content; present, using the display, the image content; and present, using the speaker, the enhanced audio content.

Example 20: The electronic device of example 19, wherein the content-enhancement manager module directs the electronic device to determine the intent based, at least in part, on a machine-learned model referencing a past behavior of the user.

Example 21: A method performed by an electronic device comprising: capturing, by the electronic device, a scene, the capturing of the scene including capturing image content and audio content; determining, by the electronic device, an audio focus point within the scene; enhancing, by the electronic device, the audio content and the image content based at least in part on the determined audio focus point; and presenting, by the electronic device, the enhanced image content and the enhanced audio content.

Example 22: The method of example 21, wherein enhancing the image content includes blurring at least one feature in the image content.

### CONCLUSION

Although techniques using and apparatuses for enhancing audio content of a captured scene are described above, it is to be understood that the subject of the appended claims is not necessarily limited to the specific features or methods described. Rather, the specific features and methods are disclosed as examples of ways in which enhancing audio content of a captured scene can be implemented. Further, various different aspects are described, and it is to be appreciated that each described aspect can be implemented independently or in connection with one or more other described aspects.

1. A method (500) performed by an electronic device (102), the method comprising:
capturing (502), by the electronic device (102), a scene (104), the capturing of the scene (104) including capturing image content (118) and audio content (108, 112, 116);
determining (504), by the electronic device (102), a context associated with the capturing of the scene (104);
enhancing (506), by the electronic device (102), the audio content (108, 112, 116) based at least in part on the determined context; and
presenting (508), by the electronic device (102), the image content (118) and the enhanced audio content (120).

2. The method of claim 1, wherein enhancing the audio content includes increasing or decreasing a magnitude of at least one sound included in the audio content.

3. The method of claim 1, wherein determining the context associated with the capturing of the scene is based, at least in part, on contextual information detected by one or more sensors of the electronic device.

4. The method of claim 3, wherein the contextual information detected by the one or more sensors of the electronic device includes:
information indicative of a location of the electronic device; or
information indicative of a motion of the electronic device.

5. The method of claim 1, wherein determining the context associated with the capturing of the scene includes determining the context based, at least in part, on an analysis of the image content by the electronic device.

6. The method of claim 1, wherein determining the context associated with the capturing of the scene includes determining the context based, at least in part, on an analysis of the audio content by the electronic device.

7. The method of claim 1 wherein presenting the image content and the enhanced audio content includes presenting the image content and the enhanced audio content in real-time.

8. The method of claim 1, wherein presenting the image content and the enhanced audio content includes presenting a recording of the image content and a post-processed, enhanced recording of the audio content.

9. The method of claim 1, wherein the image content includes video content.

10. The method of claim 1, wherein the image content includes still image content.

11. The method of claim 1, further comprising:
determining an intent of a user directing the electronic device to capture the scene, the determining based, at least in part, on a machine-learned model referencing a past behavior of the user; and
wherein enhancing the audio content is further based on the determined intent.

12. A method (600) performed by an electronic device (102), the method comprising:
capturing (602), by the electronic device (102), a scene (104), the capture of the scene (104) including capturing image content (118) and audio content (108, 112, 116);
determining (604), by the electronic device (102), an audio focus point within the scene (104);
enhancing (606), by the electronic device (102), the audio content (108, 112, 116) based at least in part on the determined audio focus point; and
presenting (608), by the electronic device (102), the image content (118) and the enhanced audio content (120).

13. The method of claim 12, wherein enhancing the audio content includes using beamforming during the capturing of the audio content, the beamforming based at least in part on the determined audio focus point.

14. The method of claim 12, wherein the determined audio focus point is based, at least in part, on:
an input from a user of the electronic device;
a context associated with the capturing of the scene; or
an analysis of the image content.

15. An electronic device (102) comprising:
a processor (202); and
a computer-readable storage medium (214) comprising instructions of a content-enhancement manager module (216) that, when executed by the processor (202), directs the electronic device (102) to:
capture a scene (104), the capture of the scene (104) including capturing image content (118) and audio content (108, 112, 116);
determine an audio focus point within the scene (104);
enhance the audio content (108, 112, 116) based at least in part on the determined audio focus point; and
present the image content (118) and the enhanced audio content (120).
